(19) United States
(12) Patent Application Publication
(10) Pub. No.: US 2026/0006303 A1
(43) Pub. Date: Jan. 1, 2026

(54) Method of Creating Enhanced, Interactive Content for Objects Present in a Video and Method for Distributing the Same

(71) Applicant: Neal C. Fairbanks, Livonia, MI (US)

(72) Inventor: Neal C. Fairbanks, Livonia, MI (US)

(21) Appl. No.: 19/251,153

(22) Filed: Jun. 26, 2025

Related U.S. Application Data
(60) Provisional application No. 63/664,976, filed on Jun. 27, 2024.

(51) Int. Cl. H04N 21/8545; H04N 21/258; H04N 21/431

(52) U.S. Cl. CPC H04N 21/8545; H04N 21/25825; H04N 21/4314

(57) ABSTRACT

The present application provides system and method for providing additional information related to a primary content to a target information seeker. A system for providing additional information related to at least one primary content without disturbing the primary content, the said system comprising of: at least one color code generator adapted to generate at least color code, each color code is preconfigured with encoded data value; an embedding means adapted to embed the at least color code into at least one boundary of at least one primary content; a video/image rendering device adapted to: capture the embedded color coded primary content; extract at least one color code pattern from the captured primary content and decode at least one color code pattern to render at least one encoded data value for providing additional information related to the primary content.

### BACKGROUND

### 1. Field of the Invention

The invention generally relates to a system and method for enhancing playback of a video with clickable elements when interacted with by a viewer on an electronic device and methods for efficiently distributing the same.

### 2. Description of Related Art

Videos, such as television media content, are typically broadcast by a content provider to an end-user in either a recorded or a live format. Embedded within the videos are a plurality of objects. The objects traditionally are segments of the videos that are visible during playback of the videos. As an example, without being limited thereto, the object may be an article of clothing or a household object displayed during playback of the videos. It is desirable to provide additional information, such as advertising information, in association with the object in response to selection or “clicking” of the object in the videos by the end-user.

There have been prior attempts to provide such interactivity to objects in videos. Prior attempts traditionally require physical manipulation of the object or the videos. For example, some prior methods require the videos to be edited frame-by-frame to add interactivity to the object. Moreover, frame-by-frame editing often requires manipulation of the actual videos itself. But manipulating the videos itself is largely undesirable. Illustrative methods are shown in U.S. Pat. Nos. 5,708,845 and 6,496,981, both to Wistendahl et al. Other prior art discloses editing only selected frames of the media stream, instead of editing each of the individual frames. It is well known to those skilled in the art to define hot spots using positional data having two or three coordinates. However, one issue presented in creating these hot spots is interleaving it with the videos. Since the frames are passing at a rate of 30 frames per second, it would take considerable time and effort even for a most skilled editor. This is a major burden to be overcome in providing this functionality to users and viewers in a cost-effective manner. However, even if two frames per second were edited, for a half-hour media stream, 3,600 frames would have to be edited. This would take considerable time and effort even for a most skilled editor.

There have been other attempts to provide such interactivity to objects in videos by disposing, over the videos, a layer having a physical shape that tracks the object in the videos during playback and detecting a click within the physical shape. As one example, U.S. Pat. No. 9,888,289 is for a “Liquid Overlay for Video Content” and provides interactivity through tags that are overlaid on the video. The tags are provided in an interactive content file that overlies or floats over the objects in the video when the video is played and associated information is retrieved if the tag is selected. Such systems require the tags to be overlaid which can result in large files if there are numerous objects or if it is a long video. Another drawback is that searching and loading the floating overlies as the video progresses can result in slower performance. The layer had to be attached to the videos and the player to provide additional “front-end” processing. Thus, this prior attempt could not instantaneously provide the additional information to the end-user unless the physical shape was positioned in a layer over the object. Still another drawback is that these external layers do not integrate well into the players or viewers, because they do not allow for layer, so that it takes additional resources to integrate the layer. The additional resources consume bandwidth and many content providers will not allow such layers.

Other approaches are shown in United Patents Patent Application Publications 2014/0047483 and 2015/0177940. Each of these methods define object parameters for objects present in videos and the parameters are stored in a database separate from the videos and separate from the device that is playing the videos. When the user interacts with the video, in order to determine if the object is located at that time and location, it is necessary to communicate with the database. Still another approach is shown in WO2017/011084, and corresponding United States Patent Application Publication No. 2017/0017382, which discloses a system and method for interaction between touch points on a graphical display, and specifically for the selection of objects while viewing videos. Such systems have drawbacks if the bandwidth is limited between the user device and the database or if a content provider will not allow access outside of its network. If millions of users are selecting objects at nearly the same time, the bandwidth to make the round trip is too extensive and performance is poor. The performance is further limited if analytics are being transmitted at the same time. Further, the systems tend to be computationally intensive which results in the implementation being limited or difficult.

Another approach is disclosed in U.S. Pat. Nos. 10,477,287 and 11,032,626, which utilizes a portable package that includes all necessary assets to make the interactive elements. These portable packages can become large and consume significant bandwidth making distribution difficult or objectionable to advertisement services that have time and size limits. Additionally, the interactive elements have an associated object time that the element is interactive, which can provide computational challenges. Still another prior system and method is disclosed in U.S. Pat. No. 11,956,518, which define a shape and an object time and simplifies the computation by employing a grid. However, the grid does not provide sufficiently specific object designation when there are multiple objects of interest in the video. Moreover, this method still employs the portable package distribution which consumes bandwidth and it can encounter limitations from advertisement services and content distribution networks.

These related art methods are characterized by one or more inadequacies. Accordingly, it would be advantageous to provide a system and method that overcomes these inadequacies.

### SUMMARY

The subject invention provides a method of creating enhanced, interactive content for objects present in a video. The method includes the steps of providing an edit module having a canvas, defining a width and a height for the canvas representing a viewable area and defining an origin for the canvas. Next, the video is displayed within the viewable area of the canvas and associating the origin of the canvas with the video. A clickable element is created within the viewable area near the object to be selectable during playback of the video. The clickable element has at least one vertex defined by element coordinates that comprise an X-coordinate and a Y-coordinate. Then, an enablement flag is selected to enable the clickable element at an enabled time associated with an elapsed time of the video so that the clickable element is able to be selected. A first element data parameter is created for the clickable element that includes the element coordinates and the enabled time. The enablement flag is deselected at a time after the enabled time and the coordinates associated with the clickable element are shifted outside of the viewable area so that the clickable element cannot be selected. A second element data parameter for the clickable element is then created that includes the shifted coordinates and a disabled time associated with the elapsed time of the video when the enablement flag was disabled.

The subject invention also provides a method of distributing enhanced, interactive content for objects present in a video when the video is played on an electronic device. The method includes the steps of providing an element container associated with the video and the element container includes a plurality of clickable elements. The clickable elements have initial element coordinates that comprise X-coordinates and Y-coordinates defining the clickable element that is associated with the object. The X-coordinates and the Y-coordinates are defined relative to an initial origin for the video, so that a viewable area is established. The element container further includes a total time for the video and a plurality of element data parameters for each of the clickable elements. The element data parameter includes an elapsed time, a registered origin and a registered X-coordinate and a registered Y-coordinate for the clickable element at the elapsed time. The method receives device information related to the electronic device that includes device type, device capabilities, and network conditions and player information that includes player type to play the video and a player origin. Based on the device information and player information, a packet size is determined for the element container at a first instance and then the element container is distributed at the determined packet size for the first instance. The method continues to receive device information as the video continues to play and, as time elapses, the packet size for the element container continues to be determined as the device information is received at various instances to dynamically adjust the packet size for optimal progressive download and playback. The element container continues to be distributed until an end of the video is reached. During playback, assets associated with the element data parameter comprising object information that is associated with the object are provided. The object information associated with the clickable element is displayed to a viewer when the viewer makes a selection event at the elapsed time and based on a selection coordinate being within the registered X-coordinate and the registered Y-coordinate of the clickable element.

The subject invention further provides a system that includes the edit module for receiving or inputting video and creating the enhanced content with the clickable elements for objects appearing in the video. The clickable elements generally correspond with the objects that are present, were present, or will be present in the video. The edit module includes a canvas that displays the video to an editor. The clickable elements are represented by one or more vertices. The system also includes an element log to select and deselect the enablement flag, which is either on or off, which shifts the coordinates of the clickable element inside and outside of the viewable area. This allows for quick creation of the enhanced content because the editor does not have to recreate the clickable element when it is reenabled. Further, moving the clickable element is seamless as the X- and Y-coordinates are updated and the elapsed time is recorded. The subject invention is able to simplify and streamline the creation of the enhanced content by utilizing a single timer, the total time of the video. One advantage of using the total time, or running time, of the video as the timer, the distribution of the element container can be progressive, or broken down based on the electronic device that is viewing the video. The prior art systems were unable to progressively distribute the enhanced content because it required multiple, different timers, or complete files to be transmitted.

Because the subject invention is able to progressively distribute the enhanced content, the subject invention is able to provide longer length videos that conform to existing requirements for various different applications used to play such video.

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1 is a schematic representation of one embodiment of a system for enhancing playback of a video with clickable elements when interacted with by a viewer on an electronic device a system;

FIG. 2 is an illustration of one embodiment of an element library;

FIG. 3 is an illustration of one embodiment of an edit module;

FIG. 4 is an illustration of one embodiment of an element log;

FIG. 5 is a schematic representation of another embodiment of a system according to the subject invention;

FIG. 6 is an exemplary element container having a plurality of element data parameters;

FIG. 7 is a flow chart of one embodiment according to the subject invention; and

FIG. 8 is a flow chart of one embodiment of progressive distribution or playback.

### DETAILED DESCRIPTION

Referring to the figures, wherein like numerals indicate like or corresponding parts throughout the several views, a system is shown generally at 10 that is capable of creating enhanced, interactive content for objects 16 present in a video. The subject invention also describes a method for creating the enhanced, interactive content and a method of distributing the enhanced, interactive content for objects 16 present in a video when the video is played on an electronic device. The electronic device may include smart phones, laptops or desktop computers, tablets, televisions, and the like.

The system 10 includes an edit module 14 for receiving or inputting video and creating enhanced content with clickable elements, shown generally at 12, for objects 16 appearing in the video. The edit module 14 may reside on a computing device, which may be any type of computing device known to those of skill in the art. Examples of computing devices could be PC, servers, tablets, or the like. The computing device may be in communication with a transmitting system, if necessary. The clickable elements 12 generally correspond with the objects 16 that are present, were present, or will be present in the video. It is to be appreciated that the clickable elements 12 could be unrelated to any object 16 appearing in the video, but are likely related to other items, such as logos, ads, sponsorships, or the like. The clickable element 12, commonly referred to as “hot-spots” or “hyperlinks” are capable of being selected by the viewer and associated information is obtained or displayed once selected. It is to be appreciated by those skilled in the art that clickable element 12 may not require the element itself to be clickable but instead may refer to when the viewer attempts to click where the clickable element 12 is located such that it appears to be clickable.

The video that is received by or input into the edit module 14 may be referred to as native video and may be recorded video or live video. If the video is live video, the necessary components, such as a camera and the like would be in communication with the edit module 14 to capture the live video and provide the input to the edit module 14. Additional software or applications, such as video capture software, may be used to capture video directly or indirectly with the edit module 14. The video for playback may be distributed as recorded or streamed video using various live streaming platforms, such as youtube, vimeo, twitch as is well known in the art. The video may be transmitted in digital format or transmitted in analog format and subsequently digitized. The video may be transmitted through various advertisement services. One particular use of the subject invention is to distribute advertisements using the advertisement services that have the clickable elements 12 therein to obtain analytics and advertising information associated with the viewer, as described further below.

The edit module 14 includes a canvas 18 that displays the video to an editor (i.e., a person using the edit module 14) and a playback speed of the video can be adjusted within the canvas 18. The canvas 18 has a width and a height that represents a viewable area that the video is displayed in. The canvas 18 also has an origin that is defined to associate the video during editing and during playback. The origin can be any point represented by various coordinates, such as an X-coordinate and a Y-coordinate. Depending on the complexity of the video, additional coordinates could be used, for instance, with 3-D video or 360-degree video, a Z-coordinate may be used. It is to be appreciated that the coordinates could be differently defined other than X, Y, or Z, without deviating from the subject invention.

The canvas 18 may include an icon bar 20 located within the canvas 18. The icon bar 20 may be located on either side, top, or bottom of the canvas 18 as appropriate or preferred based on the video. The icon bar 20 can display various information about the video during playback, such as alerting the viewer to the enhanced content, displaying icons of the object 16 and the like. The canvas 18 may further include an action message area 22 for displaying messages to the viewer upon playback of the video. The canvas 18 displays an elapsed time 26 for the video and a total time 24 for the video.

The clickable elements 12 are represented by at least one vertex 28. The vertex 28 is defined by element coordinates that comprise an X-coordinate and a Y-coordinate. It is to be appreciated that other coordinates could be used based on the complexity of the video.

The edit module 14 may also include an element library 30 that has element types with predefined shapes for creating the clickable elements. For example, the predefined shape may be a circular element 32 or oval that has a single vertex 28. The predefined shape may be a square element 34 or a rectangular element having four vertices 28 or a freehand element 36 with multiple vertices 28. If the circular element 32 is selected, a default diameter may be used to illustrate the circular element 32 in the canvas 18. The vertex 28 can be selected to stretch or skew the circular element 32 into a larger or smaller circle. The circular element 32 may also be stretched or skewed such that an oval element is formed having a major and minor diameter.

In one instance the freehand element 36 can have up to twenty-five vertices 28 to allow for manipulation of the element 12 to match a shape of the object 16 in the video. Generally, a spline connects each of the vertices 28 until it is closed. Using the defined elements 12 with specific vertices 28, the computations can be completed much more efficiently. The subject invention achieves these efficiencies even with the freehand element 36 because of the defined vertices 28 simplifies the computations.

The system 10 also includes an element log 38 that displays a list 40 of clickable elements 12 that are or have been created for the video. Once the clickable element 12 is added to the canvas 18, an item 42 is added to the list 40. The element log 38 allows the editor to input a name 44 and a description 50 of the element 12 that corresponds to the object 16, an icon 48 for the element 12 and/or object 16, a link 46 or web address (URL) for information related to the object 16, or any other information about the object 16 that the viewer might be interested in. The element log 38 also has an enablement flag 52 toggle that the editor can use to enable and disable the clickable element 12. It is to be appreciated that if the enablement flag 52 is present or selected, then the clickable element 12 is enabled and will be selectable (or appear clickable) during playback of the video. In other words, if during playback of the video, the viewer is interested in an object 16 displayed in the video, and the viewer clicks or selects the area of the object 16, then object information will be displayed if the clickable element 12 was registered at that location at that time, as described below. If the enablement flag 52 is not selected, the clickable element 12 will not be selectable (or will not appear clickable) during playback. The enablement flag 52 can be toggled by the editor by selecting or deselecting the enablement flag in the element log 38.

Based on creating the clickable element 12 and selecting the enablement flag 52, the system creates a first element data parameter 56 for the clickable element 12 that includes the element coordinates and the enabled time. The first data parameter 56 may be the initial vertices 28 or may be shifted depending on where the clickable element 12 was initially created, i.e. inside the viewable area or outside of the viewable area. It is to be appreciated that the clickable element 12 for a particular object 16 may have a plurality of element coordinates through the total time 24 of the video and these are recorded as part of the element data parameter based on the elapsed time 26 in the video, when the clickable element 12 is enabled, disabled, moved or shifted altered or skewed, or the like.

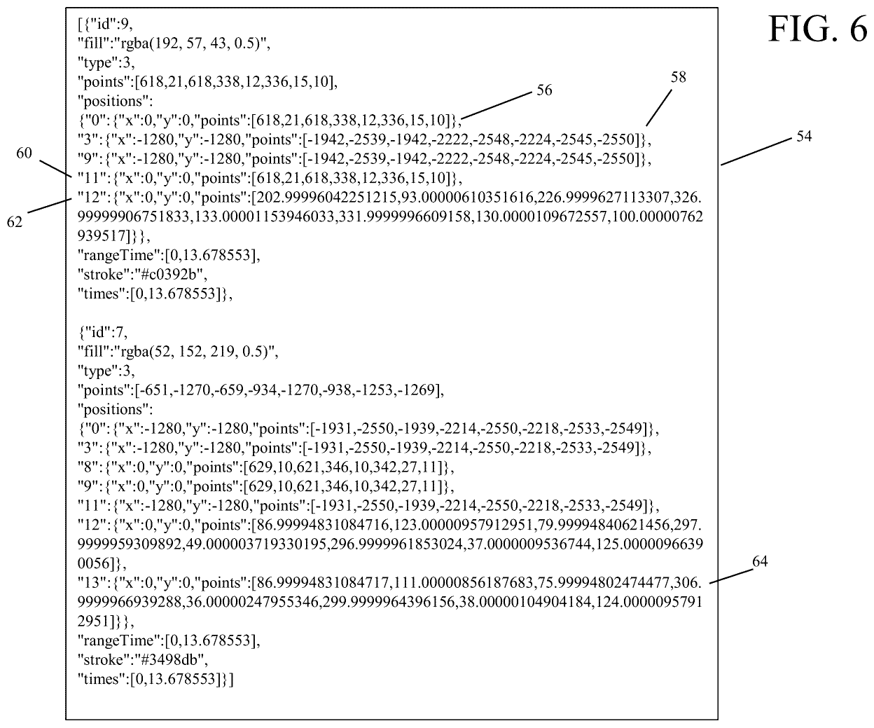

As one example, FIG. 6 shows the clickable element 12 as “id” 9 that is “type” 3, which refers to a freehand element 36. The clickable element 12 is defined by four vertices 28 at the coordinates [618, 21, 618, 338, 12, 336, 15, 10] relative an initial origin for the video, which is (0, 0). At time “0”, which is the beginning of the video, the registered origin is set as (0, 0), which aligned with a viewable area so that the registered X-coordinates and Y-coordinates of the clickable element 12 remain for a first element data parameter 56. At time “3”, the registered origin has shifted to (−1280, −1280) and the four vertices 28 are now at shifted coordinates [−1942, −2539, −1942, −2222, −2548, −2224, −2545, −2550]. The elapsed time 26 of “3” and the shifted coordinates represent a second element data parameter 58. The shift in the coordinates is a result of the editor deselecting the enablement flag for the clickable element 12 so that the clickable element 12 has been placed outside of the viewable area and the clickable element 12 cannot be selected. At time “11”, the registered origin has shifted back to (0, 0) and the four vertices 28 are now at the initial coordinates. The shift in the coordinates is a result of the editor is back inside the viewable area so that the and the clickable element 12 can be selected. The elapsed time 26 of “11” is a reenabled time and the coordinates represent a third element data parameter 60.

Once the clickable element 12 is reenabled, similar to when the clickable element 12 was initially created, the editor can move or change the shape. To move the clickable element, the editor may select a boundary and reposition the clickable element 12 within the viewable area. It is to be appreciated that some portion may extend outside of the viewable area, while a remaining portion could still be selectable. To change the shape, the editor would select a vertex 28 and resize accordingly. At time “12”, the clickable element 12 has been moved to occupy new coordinates within the viewable area and creating a fourth element data parameter 62 for the clickable element 12 that includes moved element coordinates and a moved time associated with the elapsed time 26 of the video when the clickable element 12 was moved. The total time 24 for the video is represented by “times” in the element container 54.

Referring again to FIG. 6, another clickable element 12 is shown as “id” 7 that also has an element type of “type” 3. The clickable element 12 is defined by four vertices 28 at the coordinates [−651, −1270, −659, −934, −1270, −938, −1253, −1269]. This clickable element 12 has coordinates that initially place it outside of the viewable area so it is not selectable. At time “0”, which is the beginning of the video, the registered origin is set as (−1280, −1280) so that the registered X-coordinates and Y-coordinates are [−1931, −2550, −1939, −2214, −2550, −2218, −2533, −2549], outside of the viewable area, so the clickable element 12 cannot be selected. This results because the clickable element 12 was created but the enablement flag was deselected at the beginning of the video. At time “8”, the registered origin has shifted to (0, 0) and the four vertices 28 are now at shifted coordinates [629, 10, 621, 346, 10, 342, 27, 11]. The elapsed time 26 of “8” and the shifted coordinates represent the second element data parameter 58. The shift in the coordinates is a result of the editor selecting the enablement flag for the clickable element 12 so that the clickable element 12 has been placed back inside of the viewable area and the clickable element 12 can be selected. At time “11”, the enablement flag was deselected, and the clickable element 12 was shifted outside of the viewable area. At time “12”, the enablement flag has again been selected, and the clickable element 12 is returned to be viewable area, but the coordinates have been shifted. At time “13”, at least one vertex 28 of the clickable element 12 was selected and repositioned to occupy new coordinates within the viewable area. A fifth element data parameter 64 was created for the clickable element 12 that includes resized element coordinates and a resized time associated with the elapsed time 26 of the video when the clickable element 12 was resized.

Generally, the element data parameters described above have X- and Y-coordinates, but it may also include a Z-coordinate for the clickable elements 12 for certain types of video, such as 3-dimensional or 360-degree. Typically, the vertex 28 coordinates would not be displayed to the editor but are created as a result of the editor enabling and disabling the enablement flag. Of course, the editor may be able to access the coordinates to make changes if needed. The origin may be located in the upper left hand corner of the edit module 14. However, it is to be appreciated that the origin may be any other location. During playback, knowing the origin allows the enhanced content to be aligned with the video so the clickable elements 12 appear in the correct spot to the viewer.

The edit module 14 also provides other menus, such as save, publish, quit, reports, admin, and help. It is to be appreciated that other standard menus may be used without departing from the subject invention.

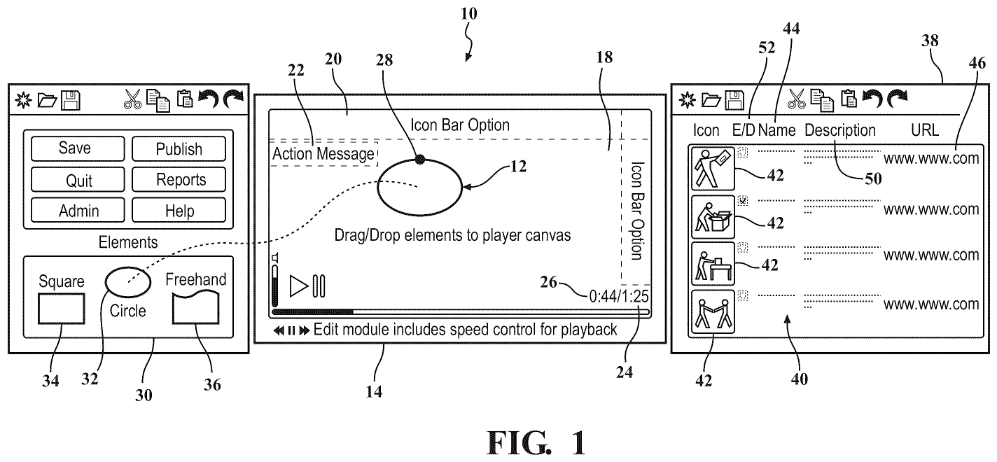

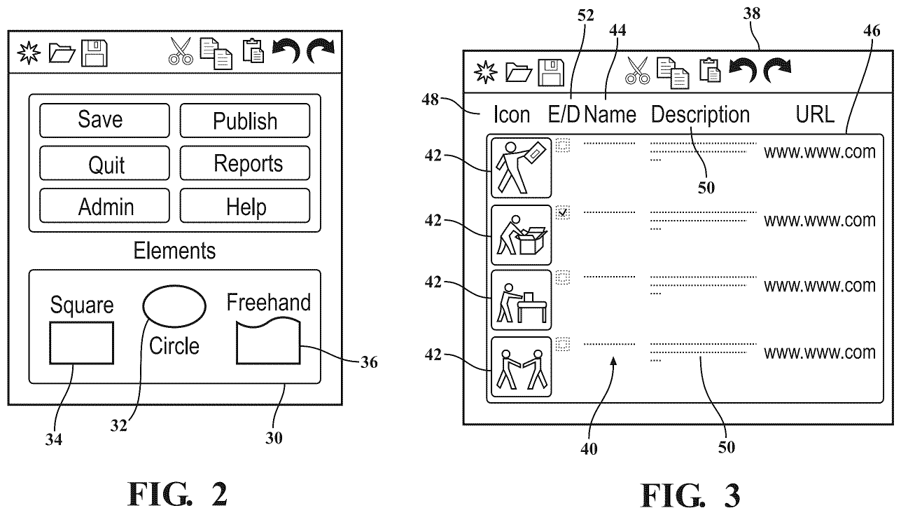

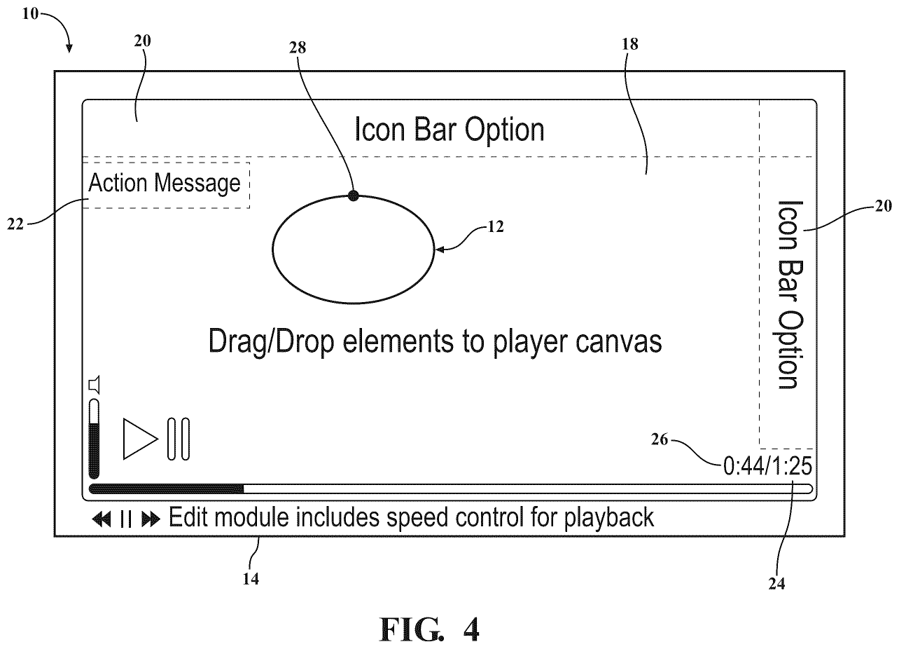

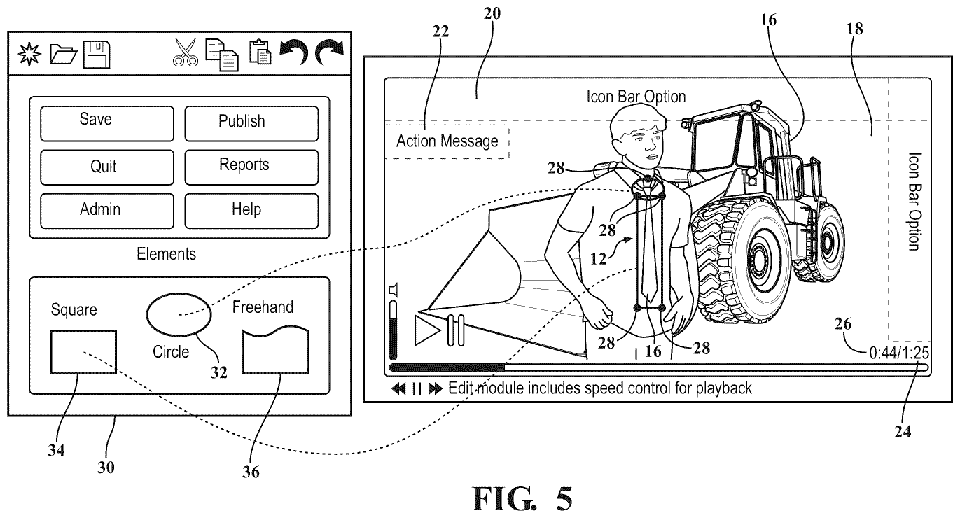

The edit module 14 may further display the element library 30, the canvas 18, and the element log 38 in a same interface or as separate interfaces. Referring to FIG. 1, a schematic is shown with the edit module 14 as a single interface. FIGS. 2-4 show the element library 30, the canvas 18, and the element log 38 as separate interfaces. Additionally, the display may be in a static view or with pop-up views as needed in response to the editor inputs.

During the editing process, in one embodiment, if an object 16 of interest is present in the video, the editor selects the element type, and drags and drops the element type (for example the circular element 32) onto the canvas 18 at or adjacent to the object 16. The circular element 32 may completely surround the object 16 or only partially surround the object 16. The circular element 32 is then added to the list 40 of elements 12 in the element log 38. The enabled time for the circular element 32 and vertex 28 coordinate for the circular element 32, having a singular vertex 28, are recorded or noted as the first element data parameter 56. The enabled time is synchronized with the time of the video playback, or elapsed time 26, when the element 12 was inserted. In the example using the circular element 32, the vertex 28 coordinates of the circular element 32 can be based on a default diameter relative to the vertex 28. If the object 16 moves in the video, the circular element 32 can be dragged to approximate the changing position of the object 16 in the video and the vertex 28 coordinates are recorded or updated for that elapsed time 26. As the object 16 is moved, if the size of the object 16 changes, the circular element 32 can be resized by stretching or skewing the circular element 32 to approximate the size and the vertices 28 would be updated. If the object 16 disappears from the video, the enablement flag 52 for the element 12 is deselected and the clickable element 12 is shifted out of the viewable area. If the object 16 re-appears in the video, the editor can reenable the element 12 by selecting the flag status, which activates the element 12. The enabled time is recorded.

When the editing sequence is complete, one element 12 may have multiple enabled and disabled times and may have multiple vertex 28 coordinates at different times throughout the video playback, as shown in FIG. 6. The subject invention does not require any separate timers for any of the elements 12 as shown in the related art, which simplifies the processing and distribution of the enhanced content.

The subject invention allows for multiple elements 12 to be stacked and occupy the same coordinates at the same time. In other words, the elements 12 can overlap with one another and depending on the flag status for each element 12, different behavior can result. If a viewer selects a coordinate that has multiple elements 12 that are enabled (enablement flag status on) at the same time, then information about all the clickable elements 12 that are enabled would be displayed. If any of the elements 12 at those coordinates is not enabled or disabled, then the object 16 information would not be displayed. While this is helpful for two-dimensional (2-D) video, it is particularly helpful for three-dimensional (3-D) video and 360-degree video that provides a viewer with a more enhanced viewing experience. The subject invention is able to quickly and easily enable or disable any one of the elements 12 occupying the same or similar coordinates by turning on/off (or selecting/deselecting) the enablement flag status to enable/disable the element 12.

Referring back to FIG. 5, the subject invention also allows for the elements 12 to be additive or combinable. For example, if the editor drags and drops a square element 34 onto the canvas 18 and then drags and drops a circular element 32 onto the canvas 18 adjacent to or touching the square element 34, those elements can be added together to form one combined element, such that the editor is able to move the element parameter data as if one, even though the system may still recognize the initial two shapes and may display the clickable element 12 in the element list as sub-elements. This combined element would still have vertices 28 of the original clickable elements 12 and the combined element can be stretched or skewed as the object 16 moves throughout the video.

During playback of the video that has enhanced content, an elements container is provided, which is represented by the exemplary data shown in FIG. 6 generally at 54. In one particular advantageous method, the element container 54 is provided to the mobile device using progressive distribution techniques. The element container 54 is derived from database queries and other stored data recorded during the editing process described above. One such format for providing the element container 54 is in JavaScript Object 16 Notation (JSON) format. Other formats, such as HTML, may be used to distribute the element container. The video is generally provided separately from the elements container 54. For shorter videos having smaller amounts of content, such as for videos less than 5-16 seconds, then the distribution may include the complete elements container 54. For the partial elements container 54, the elements containers 54 may be dynamic and created in response to a request from the viewer and the mobile device. In other words, the partial elements containers 54 are provided on-demand as the viewer is viewing the video. By creating and distributing the elements container 54 on-demand using progressive distribution for playback, the subject invention minimizes file size and bandwidth consumption during distribution. Additionally, each distribution can be adjusted or tailored to a specific electronic device or compensated for environment standards and allows for the progressive element container 54 playback. This allows each distribution to be adjusted or tailored to a specific electronic device or compensated for environment standards and allows for the progressive download and playback of the element container.

The method according to one embodiment of the subject invention receives device information related to the electronic device that comprises device type, device capabilities, and network conditions and player information for a player that comprises player type to play the video and a player origin. Localization determines the location of the electronic device based on an IP address, delivers appropriate interface language, and records appropriate date/time/location as part of analytics. Other examples of device information include screen resolution (to choose appropriate video resolution), supported video formats/codecs (e.g., H.264, VP9), and available storage (to ensure space for buffering). Additionally, the device information can include current bandwidth or connection speed, latency and packet loss (to estimate buffering needs), user-agent string (helps identify browser and OS), and HTML5 video support or plugin requirements.

Based on the device information at a first instance, a packet size for the element container 54 is determined and distributed to the electronic device. The method continues to receive device information as the video continues to play and as time elapses and the packet size for the element container 54 continues to be determined as the device information is received at various instances to dynamically adjust the packet size for optimal progressive download and playback. The element container 54 continues to be distributed until an end of the video is reached, such as when the total time 24 for the video has elapsed. If the electronic device is slow or has a low bandwidth, then the partial elements container 54 may have a shorter distribution, such as providing only 2 seconds of enhanced content at a time, for the entire length of the video. The polling of the element container 54 can be at preset intervals. If the electronic device is faster or has a higher bandwidth, then longer segments of enhanced content are provided as the partial elements container 54.

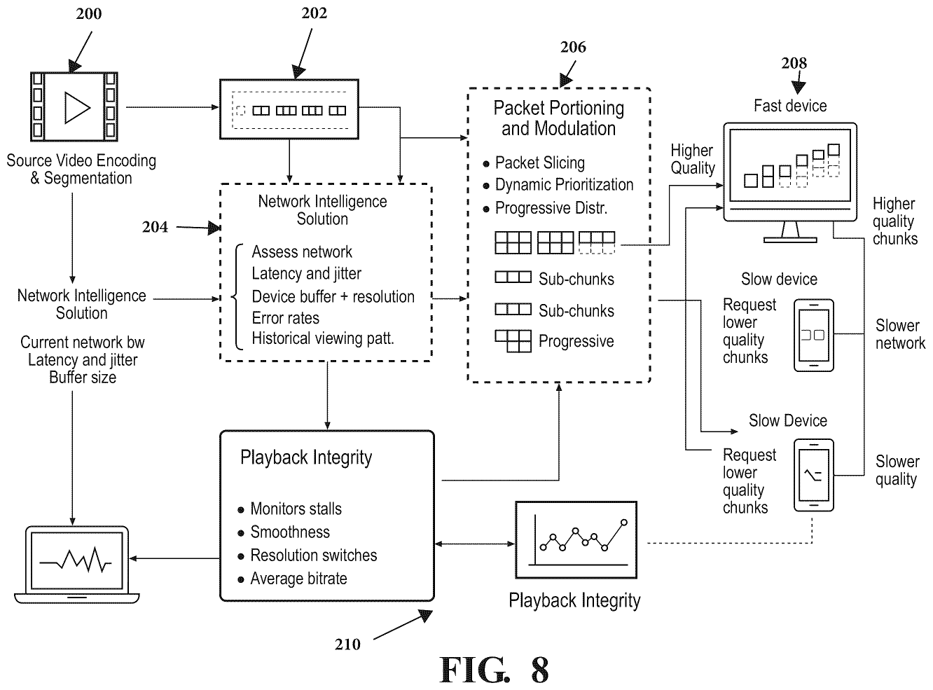

By utilizing progressive distribution of the element container 54 playback, the subject invention can provide many hours of video and enhanced content without burdening the distribution system and the electronic device. Different buffering strategies can be used for different device information or different player information to provide optimal playback and interactivity. The buffering strategies can consider, how much data the player wants to buffer before starting playback, whether the player supports seeking and how it handles partial downloads, whether the viewer is likely to watch the whole video or skip around (e.g., based on past behavior or video type), whether enough data is sent to allow playback to begin quickly without stalling, or whether the viewer may request specific byte ranges of the file (e.g., if the viewer seeks to a later part). Referring to FIG. 8, a flow chart of one embodiment of progressive distribution or playback is shown. In Step 200, the video is encoded and segmented. Encoding can be accomplished at multiple quality levels (bitrates) using codecs like H.264 or H.265. The video is segmented into small, sequentially numbered chunks (e.g., 2-4 seconds each) and each segment is stored in a media server or distributed via a CDN (Content Delivery Network), in Step 202. A network intelligence solution (NIS), in Step 204, assesses variables, such as current network bandwidth, Latency and jitter, device buffer size, CPU/GPU performance, and screen resolution, error rates and packet loss, and historical viewing patterns (predictive modeling). The NIS quickly builds a real-time, dynamic device capability profile used to guide playback efficiency. The method utilizes packet portioning and modulation to optimize playback. This includes packet slicing, dynamic, prioritization, and progressive distribution, in Step 206. For packet slicing, segments are portioned into even smaller sub-chunks or “mini-packets” to reduce startup latency and enable quick buffering on low-bandwidth devices. For progressive distribution, a base configuration (low-res) is streamed first, followed by enhancement configurations (such as, higher res, better quality) if conditions allow.

Shown generally in Step 208, the progressive playback at the electronic device is driven by the player capabilities. For example, a fast device may request and buffer higher-quality chunks, pre-fetch future segments for near-instant seeking, or handle high frame rates (e.g., 60 fps) and 5.1+ surround audio. A slower device may begin playback with low-bitrate segments, use a minimal buffer to reduce memory load, or switch up/down in quality based on real-time conditions using the progressive distribution. Step 210 illustrates playback integrity and quality, which continuously monitors stall events and re-buffering, playback smoothness, average bitrate, and resolution switches. Certain machine learning or AI models may auto-adjust delivery rules to avoid future playback disruptions.

Examples of the player type include, but are not limited to, Adobe Flash Player or Windows Media Player, and the like. The video may be viewed by the viewer on a visual display, such as a screen or monitor, which may be connected or integrated with the electronic device. The player may also be embedded into various websites or apps as opposed to being a standalone player as well known to those of ordinary skill in the art using various application programming interfaces that defines interactions between multiple software intermediaries and defines calls or requests that can be made, how to make them, the data formats that should be used, the conventions to follow, etc. Transmission of the video may be accomplished by satellite, network, internet, or the like. In one example, the video is provided to the viewer through a web server. Alternatively, the video is provided through third party systems.

As the element container 54 is provided, the method provides assets associated with the element data parameter comprising object information that is associated with the object 16. When the viewer interacts with the video and makes a selection event at the elapsed time 26 and based on a selection coordinate being within the registered X-coordinate and the registered Y-coordinate of the clickable element 12, then the object information associated with the clickable element 12 is displayed to the viewer.

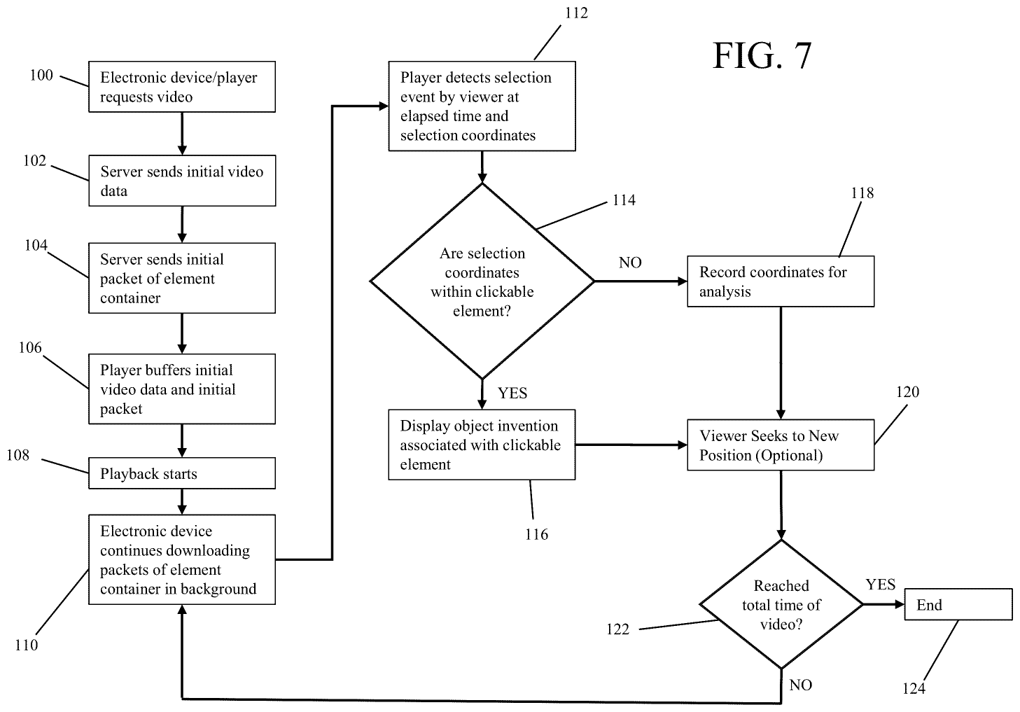

Referring to FIG. 7, a flowchart for distributing the enhanced content is shown. First, in Step 100, the electronic device or the player on the electronic device requests the video. A server with the video sends initial video data in Step 102. Contemporaneously or nearly contemporaneously, in Step 104, the initial packet of the element container 54 is transmitted. The element container 54 may be on the same server, but more likely the element container 54 is on a different server. Next, in Step 106, the player buffers the initial video data and the initial packet and playback starts in Step 108. The electronic device continues in Step 110 to download packets of the element container 54 in the background. Then, the player detects the selection event in Step 112 at the elapsed time 26 and at the selection coordinates. The method determines whether the selection coordinates are within the clickable element 12 in Step 114 and if it is, then in Step 116 the object information is displayed. If it is not, then in Step 118, the method may record the coordinates for analysis, such as for inquiring what was present at the selection coordinates and at the elapsed time 26. The viewer may seek a new position in the video, in Step 120, until the total time 24 of the video is reached, in Step 122. The video then ends in Step 124.

One possible method to detect the selection event is to use an interceptor that overlies the player. In operation, the viewer clicks in the player where the object 16 is in the video. When the viewer clicks, the selection event is registered in the interceptor. The selection event includes the selection coordinates and the elapsed time 26 of the click or selection event, collectively referred to as selection parameters. The interceptor may not be visible to the viewer. Typically, the interceptor is a clear applet or layer that detects the selection event from the viewer. In most standard players, when the viewer clicks, the video starts or stops. The interceptor intercepts and/or traps the selection parameters for further processing. The interceptor may also display standard start, stop, pause or other playback commands so that the viewer may interact more traditionally with the video. More often, if the viewer moves the input to a specific area of the player, such as near one side, top, or bottom, traditional controls or menus for the player become active. The selection event may be defined as a software-based event whereby the viewer appears to select the object 16 in the video. The player that displays the video to the viewer may employ various forms of allowing the viewer to select the object 16. For example, the selection event may be further defined as a click event, a touch event, voice event or any other suitable event representing the viewer's intent to select the object 16. The selection event may be registered according to any suitable technique.

In response to the selection event being detected, if there is the clickable element 12 at that elapsed time 26 and selection coordinates, then the information associated with the element 12 is retrieved and provided to the viewer. If there is not, then the subject invention records the selection coordinate and time for analytics review. Well known methods for determining whether the selection coordinates correspond to the clickable element 12 are used with the subject invention. For example, determining the number of splines that are encountered adjacent to the selection coordinates when inspected from one direction can determine if the selection is within a boundary of the clickable element 12. An even number indicates the selection is outside of element 12. If the number of object 16 boundaries encountered is odd, this indicates that the selection is within the element 12. Other methods may be used without departing from the subject invention.

The additional information for the object 16 may become viewable or visible to the viewer according to any suitable manner. Once the clickable element 12 is selected, the video may be stopped, and the information may then be displayed or the video may continue to play while the information is displayed. In either scenario, the information may be displayed in any one of the player and a window separate from the player. As another example, a bookmark bar may expand from one of the sides, top, or bottom of the player showing the object 16 that has been clicked. The bookmark bar may keep objects 16 previously clicked or the previously clicked objects 16 may be removed once they are no longer in the video. The bookmark bar may be displayed in the icon bar 20.

The subject invention may also include an analytics system. The analytics can be provided to an appropriate third party or back to the provider as needed. The method may be beneficially used for gathering valuable data about the viewer's preferences. One advantage of the subject invention is that it allows for collecting interactivity between the viewer interacting with the clickable element 12 and another party, such as a provider, a manufacturer of the object 16, or the editor of the edit module 14. The subject invention can detect how often the objects 16 are selected and this in turn would adjust the cost of advertising within the video. Further, the collection of the viewer data may be retained for future interaction and may even allow for tailoring the clickable elements 12 to the individual viewer based upon past selections. The clickable elements 12 that are selected may also be tracked and transmitted for instantaneous feedback for marketing and advertising. Another advantage of the subject invention is that it may be incorporated into existing systems without any additional hardware and minimal, if any, additional software.

The data related to the object 16 selected may include what object 16 was selected, when an object 16 is selected, and how many times an object 16 is selected. The method may employ any suitable technique for collecting such data. For example, the method may analyze the database and extract data related to clickable elements 12, additional information linked to elements 12, and selection events made in relation to clickable elements 12.

The method may further include the step of tracking viewer preferences based upon the collected data. The method may be utilized to monitor viewer behavior or habits. The collected data may be analyzed for monitoring which viewer was viewing and for how long the viewer viewed the object 16 or the video. The collected data may be referenced for a variety of purposes. For instance, the clickable elements 12 may be updated with the additional information that is specifically tailored to the behavior or habits of the viewer determined through analysis of the collected data related to the viewer's past selection events.

Another advantage of the subject invention is that various content distribution networks (CDN) can be used, and the enhanced content can be distributed utilizing industry standard advertising distribution environments such as DoubleClick, Centro, and Sizmek. Because the subject invention utilizes progressive distribution, it can be used with third parties that will not allow communication above certain size limits. Many of the related art systems require round trip communications for interactivity which are not supported by such third parties.

Viewers that access the CDN can retrieve the enhanced content, and the video based on the viewer location and through servers that are associated with the particular CDN. The subject invention can utilize the viewer location and connect this with the object 16 information to provide more relevant information. For example, if the viewer selects a clothing item as the clickable element 12, the system 10 can correlate the viewer location with local stores that can provide the clothing item. Alternatively, if the viewer location is such that a particular online supplier is preferred over another (such as due to local restrictions), the system 10 can provide object 16 information for that particular online supplier.

The invention has been described in an illustrative manner, and it is to be understood that the terminology which has been used is intended to be in the nature of words of description rather than of limitation. As is now apparent to those skilled in the art, many modifications and variations of the present invention are possible in light of the above teachings. It is, therefore, to be understood that within the scope of the appended claims, wherein reference numerals are merely for convenience and are not to be in any way limiting, the invention may be practiced otherwise than as specifically described.

What is claimed is:

1. A method of creating enhanced, interactive content for objects present in a video, said method comprising the steps of:
providing an edit module having a canvas;
defining a width and a height for the canvas representing a viewable area and defining an origin for the canvas;
displaying the video within the viewable area of the canvas and associating the origin of the canvas with the video;
creating within the viewable area a clickable element near the object to be selectable during playback of the video, wherein the clickable element has at least one vertex defined by element coordinates that comprise an X-coordinate and a Y-coordinate;
selecting an enablement flag to enable the clickable element at an enabled time associated with an elapsed time of the video so that the clickable element is able to be selected;
creating a first element data parameter for the clickable element that includes the element coordinates and the enabled time; and
deselecting the enablement flag at a time after the enabled time and shifting the element coordinates associated with the clickable element outside of the viewable area so that the clickable element cannot be selected and creating a second element data parameter for the clickable element that includes the shifted coordinates and a disabled time associated with the elapsed time of the video when the enablement flag was disabled.

2. A method as set forth in claim 1, further comprising the steps of reenabling the enablement flag at a time after the disabled time and shifting the element coordinates associated with the clickable element back inside the viewable area and creating a third element data parameter for the clickable element that includes the element coordinates and a reenabled time associated with the elapsed time of the video when the enablement flag was reenabled.

3. A method as set forth in claim 2, further comprising the step of creating a plurality of element data parameters for the clickable element such that the plurality of element data parameters extends a total time for the video.

4. A method as set forth in claim 2, further comprising the steps of moving the clickable element to occupy new coordinates within the viewable area and creating a fourth element data parameter for the clickable element that includes moved element coordinates and a moved time associated with the elapsed time of the video when the clickable element was moved.

5. A method as set forth in claim 2, further comprising the steps of selecting the at least one vertex of the clickable element and repositioning the at least one vertex to occupy new coordinates within the viewable area and creating a fifth element data parameter for the clickable element that includes resized element coordinates and the resized time associated with the elapsed time of the video when the clickable element was resized.

6. A method as set forth in claim 5, wherein the step of selecting the at least one vertex is further defined as selected a plurality of vertices of the clickable element.

7. A method as set forth in claim 1, wherein the canvas is further defined as including an icon bar and an action message area.

8. A method as set forth in claim 1, further comprising the step of providing an element library having element types of predefined shapes and selecting an element type with a predefined shape to create the clickable element.

9. A method as set forth in claim 8, wherein the predefined shape is further defined as a circular element having a single vertex, a rectangular element having four vertices, or a freehand element having a plurality of vertices.

10. A method as set forth in claim 1, wherein the canvas is further defined as displaying a total time for the video and the elapsed time for the video.

11. A method as set forth in claim 1, wherein the origin is further defined as an upper left hand corner of the canvas.

12. A method of creating enhanced, interactive content for objects present in a video, said method comprising the steps of:
providing an edit module having a canvas;
defining a width and a height for the canvas representing a viewable area and defining an origin for the canvas;
displaying the video within the viewable area of the canvas and associating the origin of the canvas with the video;
selecting an element type from an element library and creating within the viewable area a clickable element corresponding with the element type near the object to be selectable during playback of the video, wherein the clickable element has at least one vertex defined by element coordinates that comprises an X-coordinate, a Y-coordinate corresponding to the selected element type;
selecting an enablement flag to enable the clickable element at an enabled time associated with an elapsed time of the video when the clickable element is able to be selected;
creating a first element data parameter for the clickable element that includes the element coordinates and the enabled time; and
deselecting the enablement flag at a time after the enabled time and shifting the element coordinates associated with the clickable element outside of the viewable area so that the clickable element cannot be selected and creating a second element data parameter for the clickable element that includes the shifted coordinates and a disabled time associated with the elapsed time of the video when the enablement flag was disabled.

13. A method as set forth in claim 12, wherein the step of selecting the element type is further defined as selecting one of a circular element having a single vertex, a rectangular element having four vertices, or a freehand element having a plurality of vertices.

14. A method of distributing enhanced, interactive content for objects present in a video when the video is played on an electronic device, said method comprising the steps of:
providing an element container associated with the video, the element container comprising at least one clickable element, the clickable element having initial element coordinates that comprises X-coordinates and Y-coordinates defining the clickable element that is associated with the object, wherein the X-coordinates and the Y-coordinates are defined relative to an initial origin for the video to establish a viewable area, and wherein the element container further includes a total time for the video, and a plurality of element data parameters for the clickable element, the element data parameters comprising an elapsed time, a registered origin and a registered X-coordinate and a registered Y-coordinate for the clickable element at the elapsed time;
receiving device information related to the electronic device that comprises device type, device capabilities, and network conditions and player information for a player that comprises player type to play the video and a player origin;
determining a packet size for the element container based on the device information at a first instance;
distributing the element container at the determined packet size for the first instance;
continuing to receive device information as the video continues to play and as time elapses;
continuing to determine the packet size for the element container as the device information is received at various instances to dynamically adjust the packet size for optimal progressive download and playback;
continuing to distribute the element container until an end of the video is reached;
providing assets associated with the element data parameters comprising object information that is associated with the object; and
displaying the object information associated with the clickable element to a viewer when the viewer makes a selection event at the elapsed time and based on a selection coordinate being within the registered X-coordinate and the registered Y-coordinate of the clickable element.

15. A method as set forth in claim 14, wherein element container is written in a JavaScript Object Notation format.

16. A method as set forth in claim 14, further comprising the step of registering the initial origin and the player origin so that the X-coordinates and the Y-coordinates of the clickable element are aligned within the viewable area of the player.
